(19) United States
(12) Patent Application Publication
(10) Pub. No.: US 2026/0353057 A1
(43) Pub. Date: Nov. 5, 2026

(54) Fast Association Setup Signaling

(71) Applicant: Apple Inc., Cupertino, CA (US)

(72) Inventors: Jarkko L. Kneckt, Los Gatos, CA (US); Yong Ho Seok, Cupertino, CA (US); Yong Liu, Campbell, CA (US); Yanjun Sun, San Diego, CA (US); Veerendra Boodannavar, Cupertino, CA (US); Pooya Monajemi, Sunnyvale, CA (US); Dieter W. Siegmund, Santa Cruz, CA (US)

(21) Appl. No.: 19/659,613

(22) Filed: Apr. 27, 2026

Related U.S. Application Data
(60) Provisional application No. 63/798,401, filed on May 1, 2025.

(51) Int. Cl. H04W 8/08; H04L 1/1607; H04W 8/26; H04W 12/04; H04W 84/12

(52) U.S. Cl. CPC H04W 8/08; H04L 1/1607; H04W 8/26; H04W 12/04; H04W 84/12

(57) ABSTRACT

This disclosure relates to methods for fast association setup signaling in a wireless local area network. Key exchange signaling can be performed between a non-access point wireless device and an access point wireless device. Using key information from the key exchange signaling, protected association request and response signaling can be performed between the non-access point wireless device and the access point wireless device. The protected association request and response signaling can also include additional association setup signaling such as for Internet Protocol address setup or Block Acknowledgement setup.

### PRIORITY INFORMATION

This application claims priority to U.S. provisional patent application serial number 63/798,401, entitled “Fast Association Setup Signaling,” filed May 1, 2025, which is hereby incorporated by reference in its entirety as though fully and completely set forth herein.

### TECHNICAL FIELD

The present application relates to wireless communication, including techniques and devices for fast association setup signaling in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. For at least some wireless device use case scenarios, minimizing the delay between a request for internet traffic communication being received and performing the internet traffic communication can be important for good user experience, but maintaining constant association with an access point can be prohibitively power consumptive. Accordingly, improvements in the field are desired.

### SUMMARY

Embodiments are presented herein of, inter alia, systems, apparatuses, and methods for devices to perform fast association setup signaling in a wireless local area network.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a pair of wireless devices, such as a non-AP wireless device and an AP wireless device, can perform key exchange signaling, for example as part of association setup signaling. The key exchange signaling can be used to generate key information for authentication and to protect subsequent frame exchanges between the wireless devices.

The protected subsequent frame exchanges can include association request and response signaling, which can include additional association setup signaling, such as Internet Protocol address setup, Block Acknowledgement setup, and/or other types of association setup signaling. By including such signaling with the protected association request and response signaling, it can potentially be possible to reduce the overall delay from initiating association signaling and performing high-rate data exchange. This can potentially provide an improved user experience, at least in some instances; for example, reducing delay in this manner could have a noticeable impact for scenarios in which the association signaling is initiated based on a delay-sensitive data request. As another possible benefit, such an approach can have the potential to reduce the number of management frames communicated for association setup signaling, which can potentially reduce overhead and improve spectrum efficiency, at least in some instances.

In some embodiments, the Internet Protocol address setup time can be further reduced by requesting reuse of an Internet Protocol address corresponding to a previous association. As another possibility, Block Acknowledgement setup time can potentially be further reduced by supporting combined Block Acknowledgement requests and responses that can be used to configure Block Acknowledgement setup for multiple uplink and/or downlink user priorities in aggregate.

Various aspects of the fast association techniques described herein can be used in conjunction with multiple possible association signaling frameworks (e.g., potentially using different types of key exchange signaling), and also or alternatively can potentially be used in conjunction with seamless roaming, fast transition roaming, and/or in various other scenarios, according to various embodiments.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a signal flow diagram illustrating an example method for performing fast association setup signaling in a wireless local area network, according to some embodiments;

FIG. 6 illustrates aspects of an example data off-loading scenario for a wireless device, according to some embodiments;

FIG. 7 illustrates aspects of an example WLAN association signaling framework in which IP and data flow setup signaling is performed after initial WLAN connectivity setup, according to some embodiments;

FIG. 8 is a signal flow diagram illustrating an example signal flow in which IPv4 address setup is initiated during protected association request and response signaling, according to some embodiments;

FIG. 9 is a signal flow diagram illustrating an example signal flow in which IPv6 address setup is initiated during protected association request and response signaling, according to some embodiments;

FIG. 10 is a signal flow diagram illustrating an example signal flow in which fast initial IP address setup can be attempted when using pre-association security negotiation authentication, according to some embodiments;

FIG. 11 is a signal flow diagram illustrating an example signal flow in which BA setup is initiated during protected association request and response signaling, according to some embodiments;

FIGS. 12-13 illustrate example aspects of a possible combined AddBA element, according to some embodiments;

FIG. 14 is a signal flow diagram illustrating an example signal flow in which both IP address and BA setup are initiated during protected association request and response signaling, according to some embodiments;

FIG. 15 illustrates another example signal flow in which IP address and BA setup are initiated during protected association request and response signaling, according to some embodiments;

FIG. 16 illustrates a signal flow diagram in which extensible authentication protocol signaling can include association setup signaling to reduce the delay before high bit rate data communication can be performed, according to some embodiments;

FIG. 17 is a signal flow diagram illustrating example aspects of a possible enhanced seamless roaming signaling flow, according to some embodiments;

FIG. 18 illustrates example aspects of a possible signal flow framework for seamless roaming with inherited BA setup, according to some embodiments;

FIGS. 19-20 illustrate variations on possible signal flow frameworks for seamless roaming with IP address continuation checking, according to some embodiments;

FIG. 21 illustrates example aspects of possible fast transition over-the-air signaling that can include IP address and BA setup, according to some embodiments;

FIG. 22 illustrates example aspects of possible context creation and transfer that could be performed in a seamless mobility domain, according to some embodiments;

FIG. 23 is a signal flow diagram illustrating example aspects of a possible scenario in which context for a STA can be re-invoked after disassociating, according to some embodiments;

FIG. 24 is a signal flow diagram illustrating example aspects of a possible scenario in which a STA can perform association and context transfer signaling with a roaming AP MLD, according to some embodiments; and

FIG. 25 is a table illustrating various possible roaming and association cases that can potentially support faster, more efficient, and/or otherwise enhanced signaling, at least according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium – Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium – a memory medium as described above, as well as a physical transmission medium, such as a bus, network, and/or other physical transmission medium that conveys signals such as electrical, electromagnetic, or digital signals.

Computer System – any of various types of computing or processing systems, including a personal computer system (PC), server-based computer system, wearable computer, network appliance, Internet appliance, smartphone, television system, grid computing system, or other device or combinations of devices. In general, the term "computer system" can be broadly defined to encompass any device (or combination of devices) having at least one processor that executes instructions from a memory medium.

User Equipment (UE) (or “UE Device”) – any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA) – any of various types of computer systems or devices that perform wireless communications. A wireless device can be portable (or mobile), or can be stationary or fixed at a certain location. The terms “station” and “STA” are used similarly. A UE is an example of a wireless device.

Communication Device – any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP) – The term "Base Station" has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor) – refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11 – refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to – Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

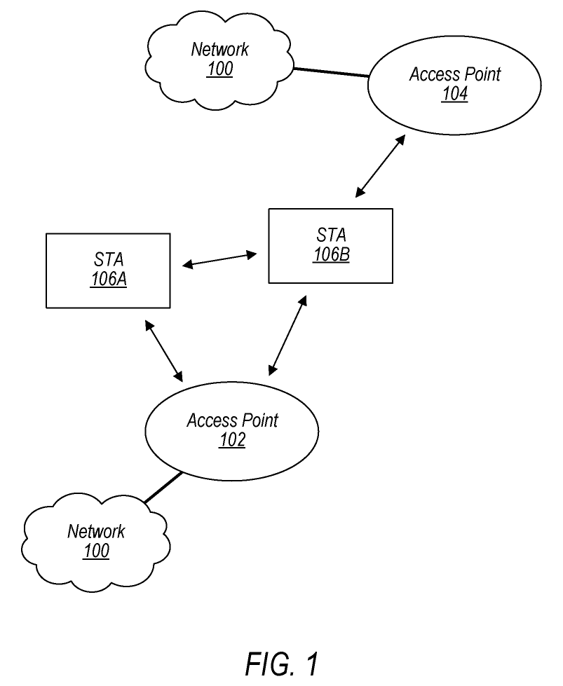

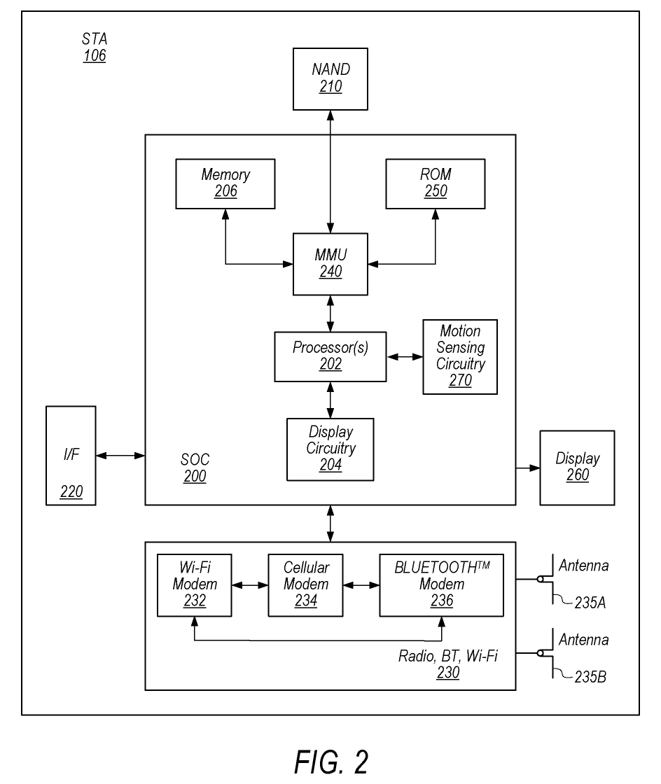

### FIGS. 1-2 – Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for fast association setup signaling in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2 – Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for fast association setup signaling described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

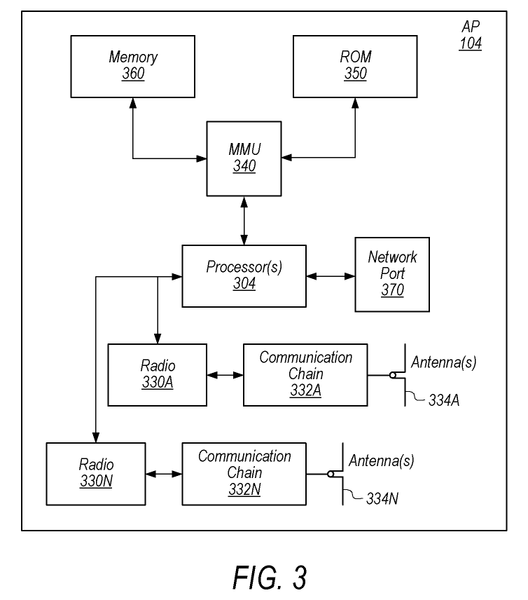

### FIG. 3 – Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as fast association setup signaling, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

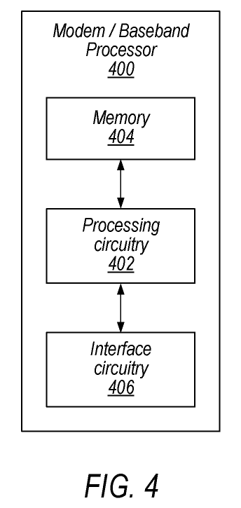

### FIG. 4 – Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio / transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as fast association setup signaling, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

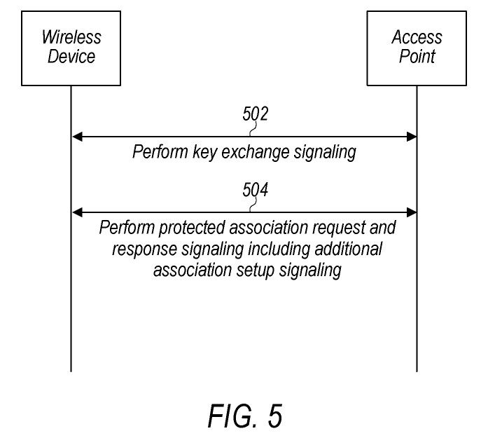

### FIG. 5 – Fast Association Setup Signaling Signal Flow

FIG. 5 is a flowchart diagram illustrating a method for supporting fast association setup signaling in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

An access point (AP) wireless device can provide one or more basic service sets (BSSs). In some embodiments, the AP wireless device can be an AP multi-link device (MLD), which can be capable of providing a BSS on each of multiple links, such as on a 2.4 GHz link, a 5 GHz link, and/or a 6 GHz link. The AP wireless device can operate in a standalone manner or can be affiliated with one or more other devices, e.g., as part of a larger network. For example, the AP wireless device could be a member of a multi-link multi-device (MLMD) or seamless mobility domain (SMD) logical entity, which could include multiple AP wireless devices, in some embodiments.

The AP wireless device can establish a wireless association with one or more non-AP (or “STA”) wireless devices. Such wireless associations can be established using Wi-Fi, wireless communication techniques that are based at least in part on Wi-Fi, and/or any of various other wireless communication technologies, according to various embodiments. For example, an access point (AP) wireless device can provide (e.g., broadcast) beacon transmissions including information for associating with the AP wireless device, and one or more other wireless devices (e.g., non-AP wireless devices) can request to associate with the AP wireless device using the information provided in the beacon transmissions, as one possibility. Use of (e.g., unicast) probe requests and probe responses can also be possible, in some instances, for a non-AP wireless device to obtain AP parameters and/or other system information for the AP wireless device. Variations and/or other techniques for establishing an association are also possible.

The AP wireless device can provide wireless local area network functionality to associated wireless devices, at least according to some embodiments. As part of the wireless local area network functionality, it can be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

For example, at least according to some embodiments, performing a downlink data transmission from the AP wireless device to a non-AP wireless device in such a wireless local area network can include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs). Note that other types of transmissions (e.g., including triggered uplink frames, enhanced distributed channel access (EDCA) uplink frames, transmission opportunity (TXOP) sharing for peer-to-peer (P2P) communications, etc.) may also be possible in such a wireless local area network.

The process of establishing association can include performing key exchange signaling between two wireless devices (502), according to some embodiments. For example, the key exchange could be performed between a non-AP wireless device and an AP wireless device for an infrastructure association link, or between peer devices for a P2P association link, as various possibilities. Various types of key exchange signaling can be possible according to various embodiments. Some examples could include one or more of enhanced data privacy key exchange (EDPKE) signaling, pre-association security negotiation (PASN) signaling, extensible authentication protocol (EAP) signaling, opportunistic wireless encryption (OWE) signaling, etc.

In some embodiments, the key exchange signaling could include a first wireless device generating and transmitting a first key exchange frame to a second wireless device. The second wireless device could receive the first key exchange frame and generate and transmit a second key exchange frame to the first wireless device. Using the information provided in the first and second key exchange frames, the first and second wireless devices may be able to derive key information that can be used to protect subsequent frame exchanges between those devices, at least according to some embodiments.

The devices can perform protected (e.g., using the key information derived from the key exchange signaling) association (or reassociation) request and response signaling that includes additional association setup signaling (504), according to some embodiments. The additional association setup signaling can include Internet Protocol (IP) address setup signaling and/or Block Acknowledgement (BA) setup signaling, among various possibilities. For example, the (re)association request and response signaling could include the first wireless device generating and transmitting a (re)association request frame that includes at least one of IP address setup signaling or BA setup signaling. The second wireless device could receive the (re)association request frame and generate and transmit a (re)association response frame that includes at least one of IP address setup or BA setup signaling. As described further herein, in some instances, an additional management frame with BA setup signaling can be generated and transmitted by the first wireless device in response to BA setup signaling included with the (re)association response frame.

Including such additional association setup signaling with (re)association request and response frames can potentially result in reduced delays to achieving data flow setup between the devices, e.g., in comparison to approaches in which such additional association setup signaling is performed later and in separate management frames, which can in turn potentially improve user experience, at least in some instances.

In a scenario in which the additional association setup signaling includes IP address setup signaling, it may be the case that a request to use an IP address from (corresponding to) a previous association can be included with a (re)association request. For example, the STA could request the AP to send an address resolution protocol (ARP) request or a dynamic host configuration protocol (DHCP) request (e.g., for IPv4 setup) and provide the response to the STA, or a STA could request router advertisement (RA) solicitation (e.g., for IPv6 setup) and the AP could provide the router advertisement, in some embodiments. An AP wireless device can potentially check whether an IP address for a non-AP wireless device from a previous association is still assigned, and can include an indication of whether an IP address from a previous association is still assigned for the non-AP wireless device with a (re)association response (e.g., in an ARP response or DHCP response). As another possibility, e.g., in the case of IPv6 setup, a router advertisement can be provided with a (re)association response that provides instructions for further signaling to continue the IPv6 setup.

Alternatively, or additionally, it can be possible that new IP address setup can be requested with a (re)association request, e.g., in case an IP address from a previous association is not available. This could potentially result in a longer delay to IP address setup than if an IP address from a previous association can be reused, but may still reduce the delay to completing IP address setup in comparison to scenarios in which IP address setup begins after association request and response signaling is complete, at least according to some embodiments.

In a scenario in which the additional association setup signaling includes BA setup signaling, it may be the case that one or more combined or aggregated BA setup requests (e.g., that request setup for multiple user priorities (UPs)) can be included with a (re)association request. For example, a combined UL BA setup request could include a UP bitmap that is configured to indicate which UL UP configurations are requested in the combined BA setup request. A combined UL BA setup response could be included with a (re)association response, e.g., to complete the combined UL BA setup for the multiple UPs. In some instances, similarly, a (re)association response could include a combined DL BA setup request, which could include a UP bitmap that is configured to indicate which DL UP configurations are requested in the combined BA setup request, and a combined UL BA setup response could be generated and provided in response to the combined DL BA setup request. Note that in some scenarios it could be the case that a (UL or DL) combined BA setup response confirms the UP configurations indicated in the corresponding combined BA setup request, while in other scenarios it could be the case that a combined BA setup response adjusts one or more UP configurations compared to the corresponding combined BA setup request; for example, it could be the case that a different BA window size could be indicated for one or more UPs in a combined BA setup response than in the corresponding combined BA setup request, as one possibility.

According to some embodiments, it can additionally or alternatively be possible for a non-AP wireless device and an AP wireless device to perform seamless roaming signaling that includes either or both of IP address continuation check signaling or BA setup signaling for seamless roaming to another AP wireless device. For example, it can be the case that a non-AP wireless device can explicitly provide an ARP request for the current IP address with a link preparation request to a current serving AP wireless device (or, alternatively, it can be the case that the non-AP wireless device need not explicitly provide an ARP request for the current IP address with the link preparation request to the current serving AP wireless device), based on which the current serving AP wireless device can in turn provide an ARP request for the current IP address of the non-AP wireless device with a link preparation request to a roaming target AP wireless device. The roaming target AP wireless device can exchange ARP request and response signaling with the distribution system (DS) to perform the IP address continuation check (and/or a DHCP request and response for the current IP address can be exchanged between the roaming target AP wireless device and the DS, e.g., if ARP timeout occurs), and can provide a link preparation response to the current serving AP wireless device with a corresponding ARP response based on the result of the IP address continuation check. The current serving AP wireless device can in turn provide a link preparation response to the non-AP wireless device with a corresponding ARP response based on the result of the IP address continuation check. The non-AP wireless device can thus setup a link with knowledge that the current IP address will work with the roaming target AP wireless device, which can have the potential to reduce data flow setup delays when performing seamless roaming to the roaming target AP wireless device.

Similarly, aggregated UL BA setup request information could be provided from a non-AP wireless device to a current serving AP wireless device with a link preparation request, and the current serving AP wireless device can in turn provide a link preparation request with the aggregated UL BA setup request information to a roaming target AP wireless device, in some embodiments. In this case, the roaming target AP wireless device can provide aggregated UL BA setup response information to the current serving AP wireless device with a link preparation response, and the current serving AP wireless device can in turn provide a link preparation response with the aggregated UL BA setup response information to the non-AP wireless device. Aggregated DL BA setup request information can also be provided from the roaming target AP wireless device to the non-AP wireless device by way of the current serving AP wireless device, in some embodiments. In this case, aggregated DL BA setup response information can be provided by the non-AP wireless device to the roaming target AP wireless device by way of the current serving AP wireless device when performing distribution system switch request signaling, at least as one possibility. The non-AP wireless device can thus setup a link with the roaming target AP wireless device with UL and DL BA setup already in order, which can also have the potential to reduce data flow setup delays when performing seamless roaming to the roaming target AP wireless device.

Still further, it can additionally or alternatively be possible for a non-AP wireless device and an AP wireless device to perform fast transition (FT) signaling that includes either or both of IP address setup signaling or BA setup signaling for FT roaming to another AP wireless device. For example, it can be the case that the non-AP wireless device can generate and transmit, to the AP wireless device, a protected FT frame (e.g., a FT 3 frame) that includes a (potentially aggregated) BA setup request (e.g., for UL BA setup) and/or an ARP request. The AP wireless device can similarly generate and transmit, to the non-AP wireless device, a protected FT frame (e.g., a FT 4 frame) that includes a (potentially aggregated) BA setup response (e.g., for UL BA setup), a (potentially aggregated) BA setup request (e.g., for DL BA setup), and/or an ARP response. It can also be the case that a further management frame can be generated by the non-AP wireless device and transmitted to the AP wireless device for further BA setup (e.g., to provide a (potentially aggregated) BA setup response (e.g., for DL BA setup). This approach can have the potential to reduce data flow setup delays when performing fast transition roaming.

Thus, according to the method of FIG. 5, it can be possible to perform fast association setup signaling, which can reduce the delay from initiating association setup to communicating data flows, reduce the total number of overhead frames needed for association setup, and/or provide any of a variety of other possible benefits, at least according to some embodiments.

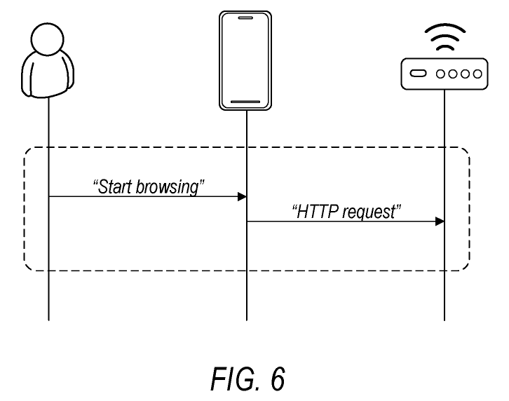

### FIGS. 6-25 and Additional Information

FIGS. 6-25 illustrate further aspects that might be used in conjunction with the method of FIG. 5. It should be noted, however, that the exemplary details illustrated in, and described with respect to, FIGS. 6-25 are not intended to be limiting to the disclosure as a whole: numerous variations and alternatives to the details provided herein below are possible and should be considered within the scope of the disclosure.

In IEEE 802.11 based wireless communication systems, it can be the case that block acknowledgement (BA) and Internet Protocol (IP) address setup is started after a wireless station (STA) is in the associated state with a serving access point (AP). This disclosure describes alternate techniques in which protected association establishment signaling can encapsulate other association setup signaling such as signaling for IP address and BA setup. This can potentially enable earlier IP address and BA setup, with corresponding shorter delays for an associated STA to transmit data, and can also potentially reduce the number of management frame transmissions used before data transmission begins.

FIG. 6 illustrates aspects of an example data off-loading scenario for a wireless device, in which aspects of this disclosure can be implemented, according to some embodiments. In the illustrated example, the (e.g., wearable or handheld) device has capabilities to communicate according to multiple radio technologies; for example, a wide-area radio can maintain connectivity to the Internet, while a WLAN radio delivers high throughput low latency real-time data on demand. As the device may be mobile (e.g., within home or office or otherwise), it can be the case that co-existence, power consumption, and/or other concerns deter against continuous WLAN radio use. For example, it can be the case that device power consumption is reduced by setting up a WLAN connection only at selected times. Thus, when user input to start browsing is received, as in the illustrated example scenario, the device can establish or re-establish connectivity with a WLAN AP to provide a HTTP request, at least as one possibility. Other use cases, such as activating an artificial intelligence personal assistant, providing a home automation command (e.g., for thermostats, light switches, etc.), and so on, are also possible.

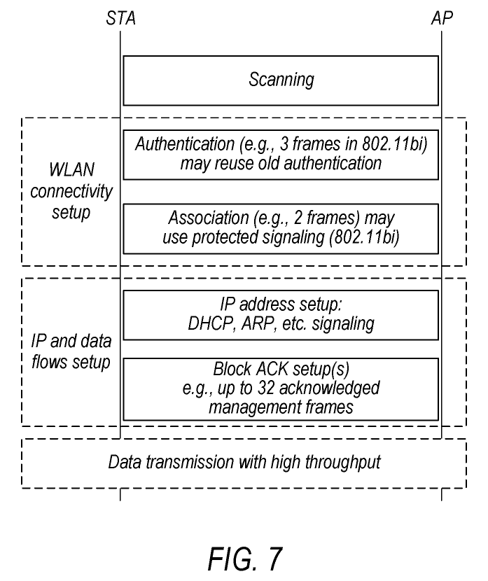

FIG. 7 illustrates aspects of an example WLAN association signaling framework in which IP and data flow setup signaling is performed after initial WLAN connectivity setup. In some embodiments, enhanced distributed protocol for key exchange (EDPKE) can be used to reduce the number of signaling frames for authentication and association. Using EDPKE, encrypted association signaling can be performed, e.g., to potentially avoid attacks on fake frames and improve STA privacy. However, in the illustrated scenario, IP address and data flow setup are still performed after WLAN connectivity signaling is complete.

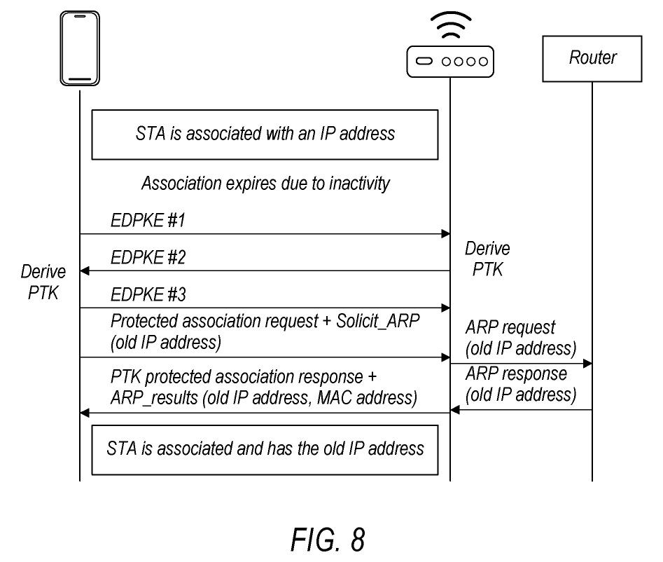

In some embodiments, it can be possible to initiate IP address and/or BA setup during initial association signaling, e.g., to reduce setup delays and management overhead. FIG. 8 is a signal flow diagram illustrating an example signal flow in which IPv4 address setup is initiated during protected association request and response signaling, according to some embodiments. The encrypted association signaling can mitigate privacy concerns for the STA to signal privacy sensitive information. As shown, in the illustrated scenario, the STA can request the AP to send an address resolution protocol (ARP) request, with the association request signaling including the IP address and the request, to check whether an existing IPv4 address from a previous association is still assigned for the STA. The AP can send the ARP request to check, and, if available, the IP address is still assigned to the STA. In some embodiments, it can be specified that the AP should send a unicasted ARP message to the router for better privacy for the STA. For instance, in comparison, it could be the case that a broadcasted ARP request message would make it easier for other STAs to detect the returning STA. The ARP Request results can be indicated in the association response signaling. The association response can include the received ARP Response frame that is transmitted as part of the Fast Initial Link Setup (FILS) Higher Layer Protocol (HLP) element. If no ARP Response is included, then it could be the case that the AP did not receive the ARP Response before it sent the association response. If the ARP response is received, data transmission can potentially start immediately using the IPv4 address. If the IPv4 address is not assigned, the STA may perform new IP address setup in the associated state. The EDPKE #3 frame and the Protected association request can be transmitted in two separated signaling messages transmitted by the STA to the AP.

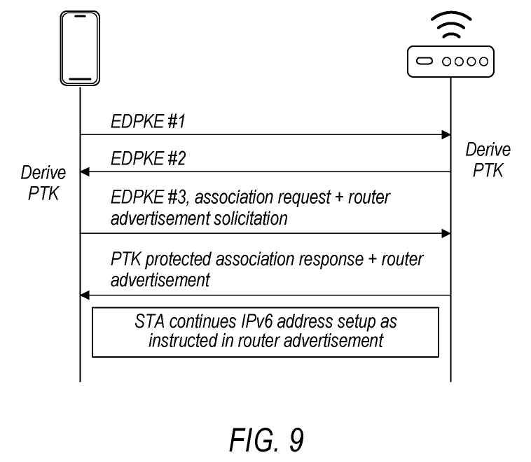

FIG. 9 is a signal flow diagram illustrating an example signal flow in which IPv6 address setup is initiated during protected association request and response signaling, according to some embodiments. In the illustrated scenario, the IPv6 address assignment can start from the router advertisement (RA), which can be included with the association request signaling. Non-AP STA data transmission delays can be reduced by soliciting an encapsulated router advertisement to the (re)association response. The associated STA can continue IPv6 address setup according to RA information. The EDPKE #3 frame and the Protected association request can be transmitted in two separated signaling messages transmitted by the STA to the AP. In some embodiments, it can be specified that the Protected Association Response may always include the Router Advertisement element, if the AP supports fast IPv6 setup. This can potentially simplify the operation, e.g., as in this case it can be possible that the STA does not need to explicitly request the router advertisement. It can be the case that STAs that cannot receive this element can ignore it. The Router Advertisement can be included in a Fast Initial Link Setup (FILS) Higher Layer Protocol (HLP) element.

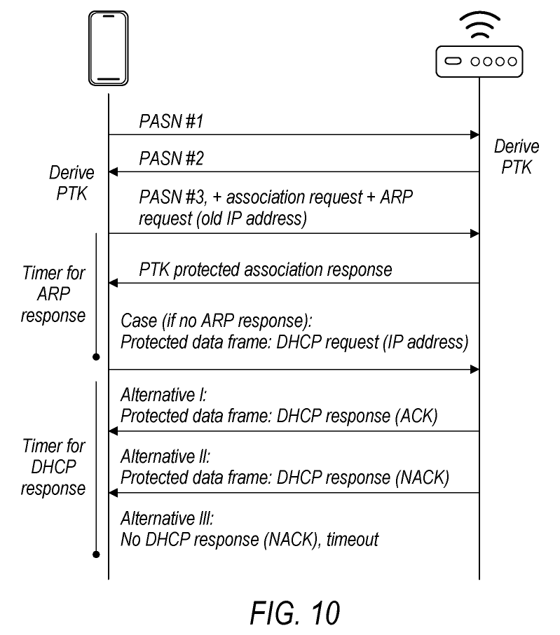

FIG. 10 is a signal flow diagram illustrating an example signal flow in which fast initial IP address setup can be attempted when using pre-association security negotiation (PASN) authentication, according to some embodiments. In this example scenario, the PASN #3 frame encapsulates the signaling (e.g., ARP request) to take the previously used IP address into use. The signaling continues in the following setup messages. Similar to FIG. 8, if the AP sends an ARP response indicating that the IP address is assigned for the STA, the STA can continue to operate the IP address, the association and IP address setup are complete, and the STA can send data to the AP using the ‘old’ IP address. Alternatively, as shown, if no ARP response is received (e.g., within an ARP response timeout), the STA can send a dynamic host configuration protocol (DHCP) request, e.g., to request again the IP address that was previously in use. If the DHCP response indicates ACK, the STA can continue to use the same IP address. If the DHCP response indicates NACK, or if there is no DHCP response, then the STA can discard the IP address and try to obtain a new IP address. These operations can potentially take longer to complete than if the previously used IP address can continue to be used, but the total setup time can still be reduced due to starting the IP address setup time earlier. In these steps, the STA can operate according to default IP address setup logic, which can allow visibility on the received messages and control for the STA on the status of the IP address setup. The EDPKE #3 frame and the Protected association request can be transmitted in two separated signaling messages transmitted by the STA to the AP.

Note that according to various embodiments, it can be the case that a media access control (MAC) address or a distribution system (DS) address of a STA can be used when requesting an IP address. At least in some instances, it may be the case that the DS address use can allow a STA to request a previously used IP address, with reduced risk of over-the-air (OTA) privacy leaks.

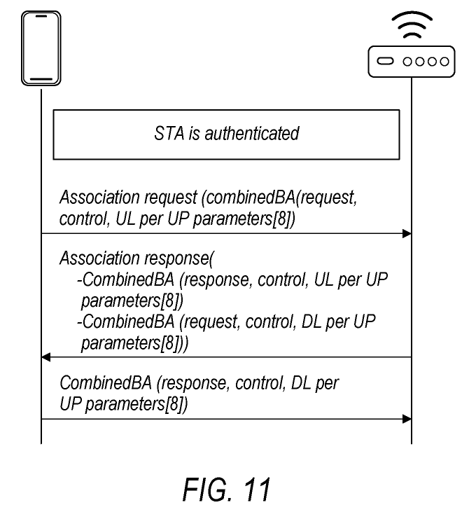

As previously noted herein, in addition or alternatively to initiating IP address setup during initial association signaling, it can be possible to initiate BA setup during initial association signaling. FIG. 11 is a signal flow diagram illustrating such an example signal flow in which BA setup is initiated during protected association request and response signaling, according to some embodiments. As shown, the association request can include a (e.g., new) ‘combined AddBA’ element that can begin BA setup for multiple (possibly all) uplink (UL) user priorities (UPs), at least according to some embodiments. For example, the element can indicate UL per UP parameters requested by the STA. The association response can carry the UL BA response (e.g., which can indicate UL per UP parameters accepted by the AP) and a DL BA request. The DL BA request can similarly indicate DL per UP parameters requested by the AP. An additional combined BA management frame can be used to communicate all DL BA responses from the STA to the AP.

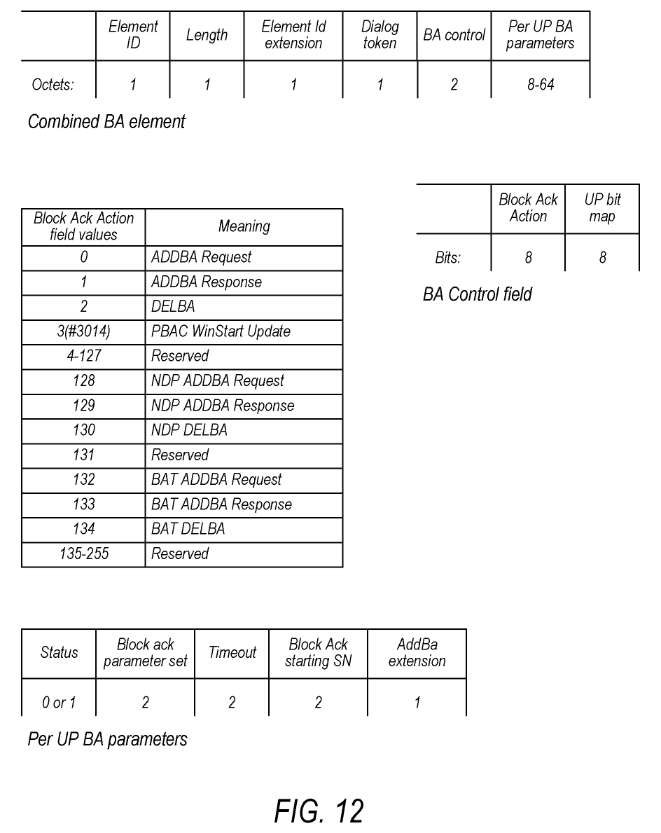

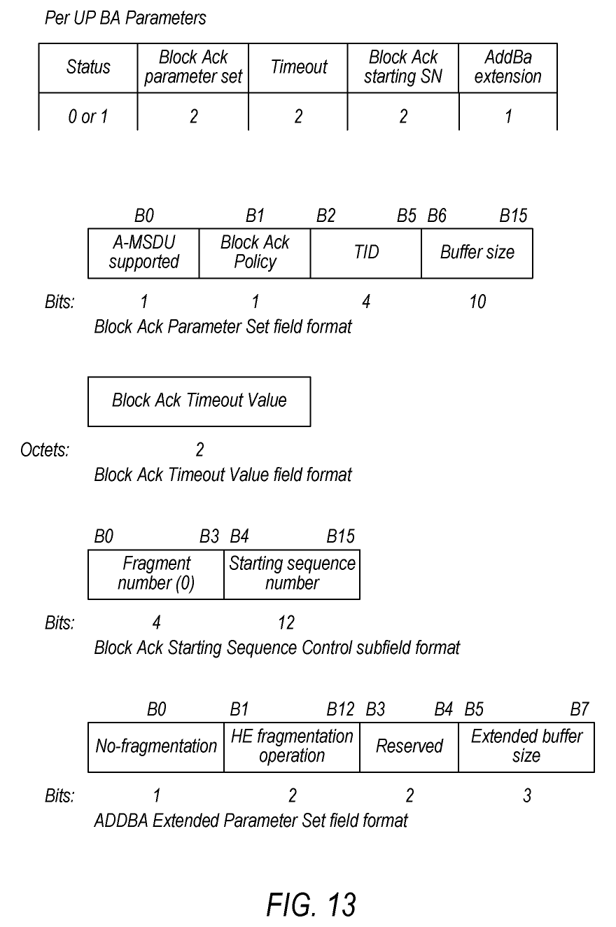

FIGS. 12-13 illustrate example aspects of such a possible combined AddBA element, according to some embodiments. As shown, the combined BA element can signal AddBA Request, Response, and/or delete (‘DelBA’) signaling for all UPs, at least in some instances. It can be the case that the Block Ack Action field defines the frame type; the same codes can be used as in management frames, and one action performed per combined BA element, according to some embodiments. A UP bitmap can signal which UPs are configured in the new BA Control field. For example, each bit position in the UP bitmap can correspond to a particular UP, and a value of 1 for a bit position can indicate that UP info is present for the corresponding UP. The Per UP BA parameters can signal the UP specific BA fields. These fields can be the same as in AddBA frames (possibly including status only in a AddBA response frame), as one possibility, and may possibly not be present in DelBA frames. Note that variations on or alternatives to some or all aspects of the illustrated combined AddBA element format are also possible.

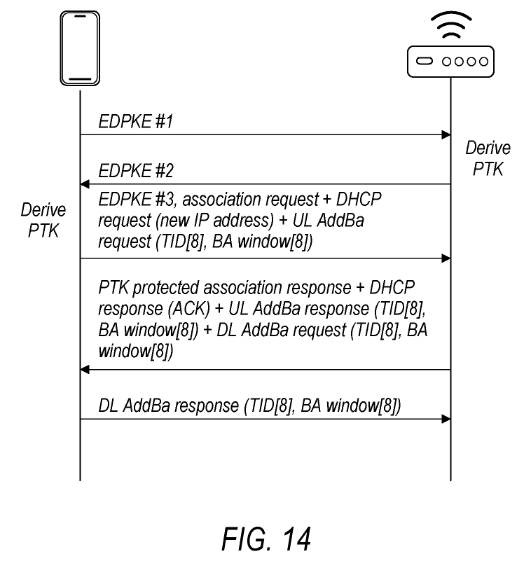

FIG. 14 is a signal flow diagram illustrating an example signal flow in which both IP address and BA setup are initiated during protected association request and response signaling, according to some embodiments. As shown, in this case, a protected association request frame can include a DHCP request and a UL AddBA Request. A protected association response frame can include a DHCP response, a UL AddBA response, and a DL AddBA request. An additional management frame can be provided to the AP by the STA to indicate the DL AddBA response. This approach can both reduce the number of setup signaling frames used and reduce the setup delays to begin communicating data flows. Since the IP address and BA setup can potentially be repeated in every association, these techniques can accordingly have the potentially to be particularly impactful for use cases in which device power consumption is reduced by setting up WLAN connection only when needed by still providing rapid response to user input requesting high throughput low latency real time data, at least according to some embodiments. Note that in some embodiments, the EDPKE #3 frame and the Protected association request can be transmitted in two separated signaling messages transmitted by the STA to the AP.

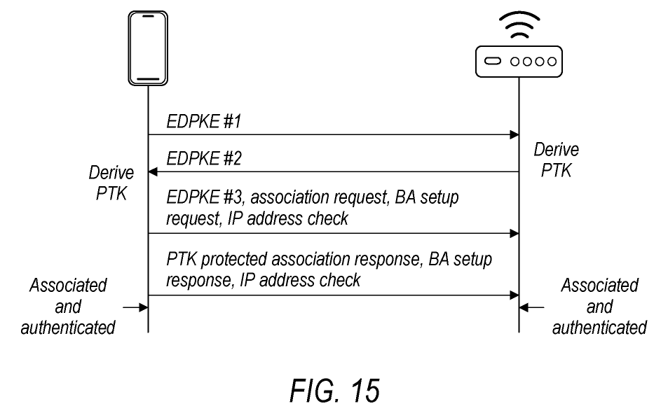

FIG. 15 illustrates another example signal flow in which IP address and BA setup are initiated during protected association request and response signaling, according to some embodiments. In particular, the approach illustrated in FIG. 15 can be used for opportunistic wireless encryption (OWE) association and key setup scenarios. As shown, an enhanced EDPKE protocol can be used for pairwise transient key (PTK) setup. Association parameters can be setup as part of the association signaling, potentially including BA setup request/response signaling and/or IP address setup signaling, at least in some instances. Similar to other scenarios described herein, this can also potentially lead to faster setup with less overhead. In this case as well, the EDPKE #3 frame and the Protected association request can be transmitted in two separated signaling messages transmitted by the STA to the AP, if desired.

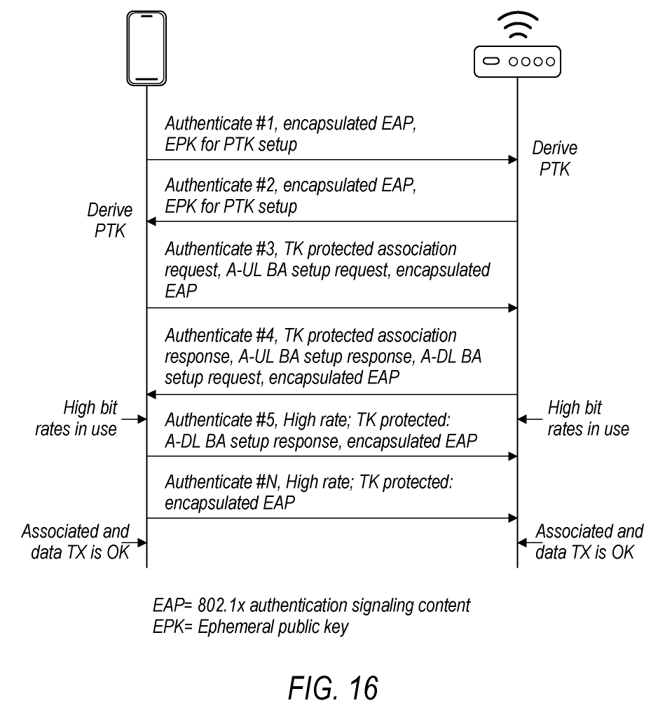

FIG. 16 illustrates a signal flow diagram in which extensible authentication protocol (EAP) signaling can include association setup signaling to reduce the delay before high bit rate data communication can be performed, according to some embodiments. It can be the case that the number of transmitted frames in enterprise 802.11x authentication is not limited, and some authentication schemes may transmit multiple frames. To obtain higher transmission rates faster, as one possibility, it can be the case that a STA can associate after a temporary key is setup. The temporary key can protect the privacy of the association signaling. The association can improve data transmission efficiency, for example potentially including enabling Trigger based (TB) and Multi-user (MU) transmissions and high data transmission rates. It can be the case that the data transmission and IP address setup are available only after authentication. If the EAP authentication fails, the STA association can be silently discarded, at least in some instances.

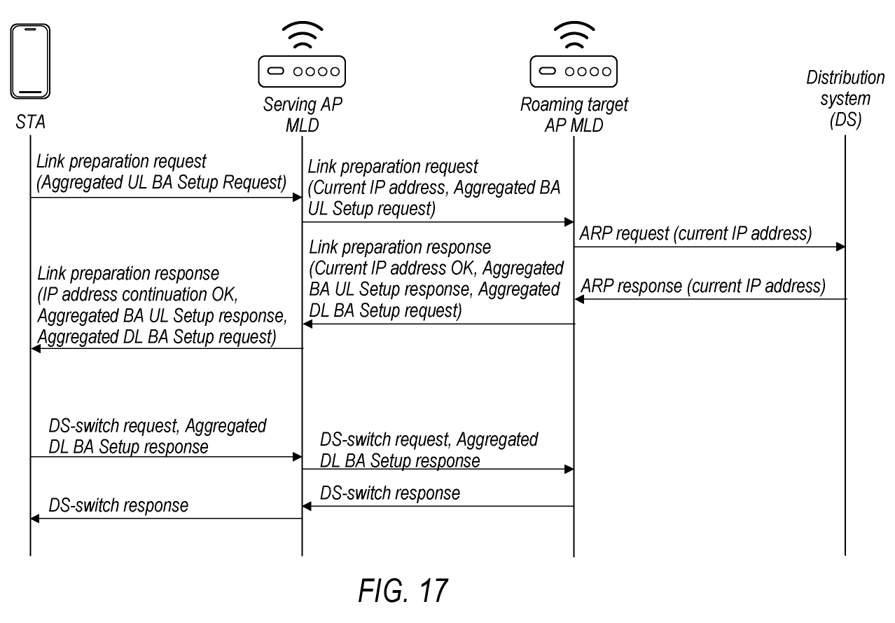

In some embodiments, it can be the case that enhanced signaling for more smoothly performing seamless roaming (e.g., within a seamless roaming domain) can also be possible using techniques described herein. FIG. 17 is a signal flow diagram illustrating example aspects of such a possible seamless roaming signaling flow, according to some embodiments. As shown, the fast initial association setup signaling approach can also be used for seamless roaming and fast transition; the IP address continuation can be checked before the seamless roaming, such that the STA can know in advance whether the IP address continuation in the roaming target AP is possible. Additionally, BA settings can be changed in a small number of frames if needed.

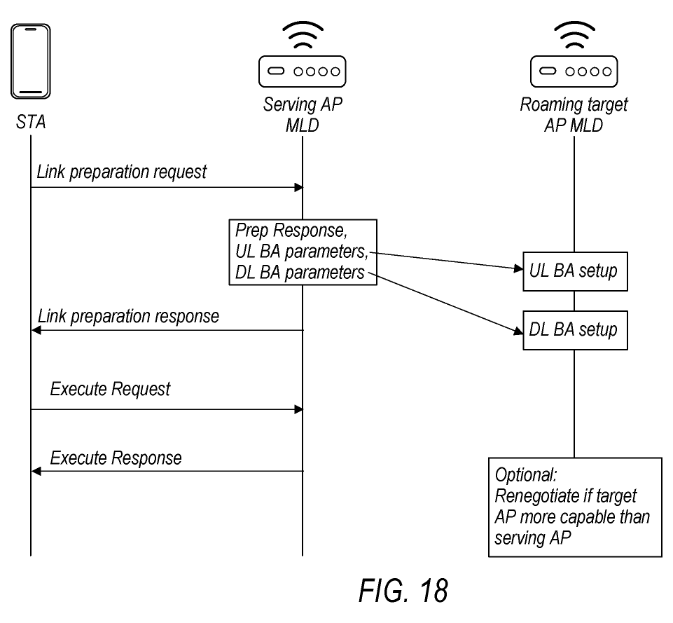

In one set of embodiments, it can be the case that the roaming signaling only needs to include BA settings that differ from those in use with the current AP MLD. For example, if the STA does not include BA parameters in the roaming preparation request frame, then the BA settings for each TID can be determined by taking the minimum of: (1) the existing BA agreement, and (2) the BA parameters supported by the target AP MLD, at least as one possibility. If the target AP MLD supports equal or greater BA parameter capability (larger BA Window or Reorder buffer size), then the existing BA agreement can be carried over unchanged. If the target AP MLD supports one or more lower capability BA parameters, then those parameters can be applicable for the roaming target AP MLD. In all these cases, the AP MLD can include information indicating the UL and DL BA parameters in use in the roaming target AP MLD in the roaming preparation response frame, at least according to some embodiments. The non-AP MLD and/or the target AP MLD can update the BA parameters after the STA has roamed to the AP MLD. FIG. 18 is a signal flow diagram illustrating example aspects of such a possible seamless roaming signaling flow, according to some embodiments.

In some embodiments, there can be additional rules for the BA update parameters in the SMD roaming. For instance, it could be the case that the BA parameters may be updated only if the non-AP MLD requests new BA parameters setup in the roaming preparation request frame. This approach can potentially give the non-AP MLD control over the complexity of the roaming preparation signaling. In some instances, both the non-AP MLD and AP MLD may advertise (e.g., set a capability bit indicating) support for the BA update during the SMD roaming. In this scenario, it can be the case that the BA agreement renegotiation may be done only if both devices support the BA negotiations in the SMD roaming.

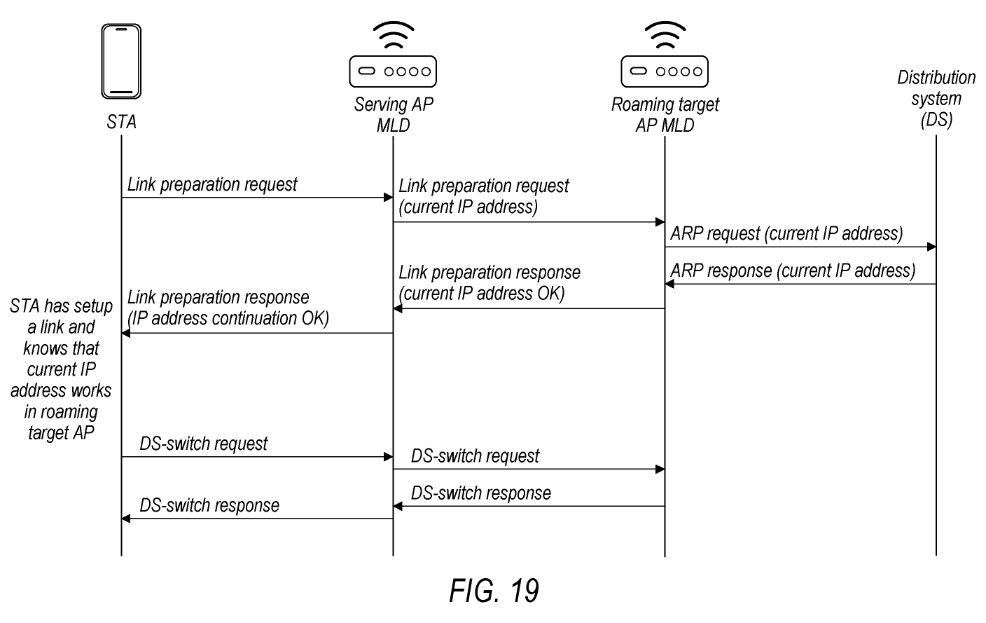

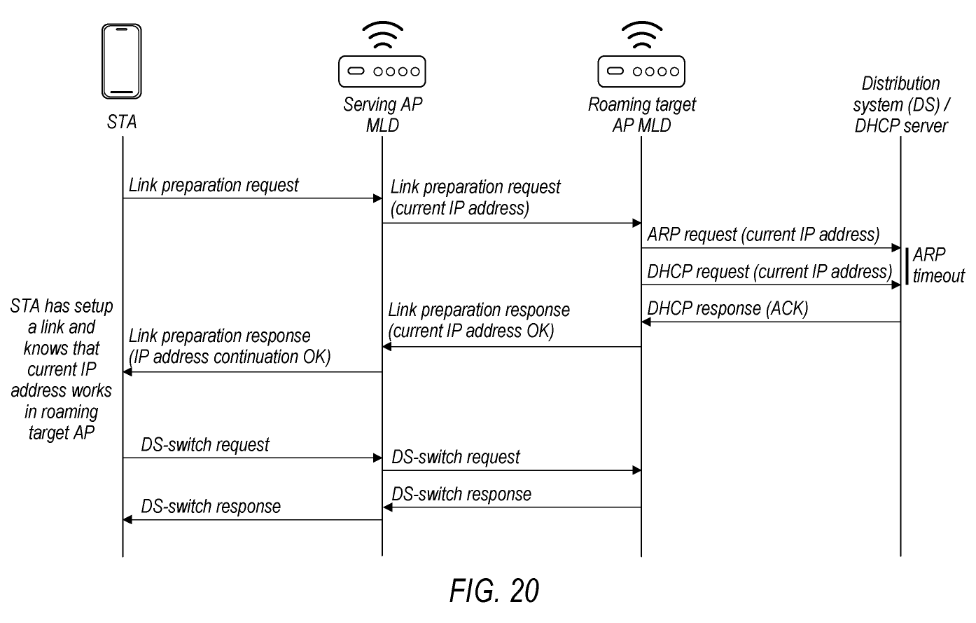

FIGS. 19-20 illustrate variations on possible signal flow frameworks for seamless roaming with IP address continuation checking, according to some embodiments. In some instances, IP address is assumed to continue in seamless roaming; however, it can also possibly be the case that seamless roaming may not be granted in this case because a network may be configured to different backbones. Accordingly, it can be useful for a STA to be able to test the IP address continuation through the old serving AP. As one possibility, a link preparation request can embed an ARP request message with the current STA IP address. The serving AP can forward the ARP request to the roaming target AP, and the ARP responses can be forwarded back to the serving AP. The STA can use ARP and DHCP signaling to verify that the roaming target AP is on the same IP network and the IP address continuation is supported. As another possibility, as shown in FIG. 19, it can be the case that the explicit IP address signaling from the STA is not needed. In this case, the STA can request a check for the IP address continuation in the link preparation request frame. The serving AP can add the STA IP address to the link setup request. The roaming target AP MLD can check IP address continuation by sending an ARP request to the DS (e.g., OTA). The roaming target AP can receive the ARP response indicating that the IP address is in use by the STA. If the ARP response is received, the AP can respond that IP address continuation is allowed.

If the AP does not get a successful response, as shown in the scenario of FIG. 20, that can mean that the new network does not have the IP address available. The roaming target AP MLD can continue to obtain an IP address by sending a DHCP request frame with the IP address requested by the roaming STA. A DHCP ACK can confirm that the IP address is available for the STA. It is also possible that the roaming target AP can get a negative result from the IP address reservation attempt, for example if the roaming target AP does not receive a DHCP response or the DHCP response has a NACK. In these cases, the roaming target AP may allocate a new IP address for the STA. The new allocated IP address may be signaled in the Link Preparation Response. It can then be the case that the roaming STA uses this address with the roaming target AP MLD, and the roaming STA can prepare applications for the IP address change when the data is transmitted by the new AP.

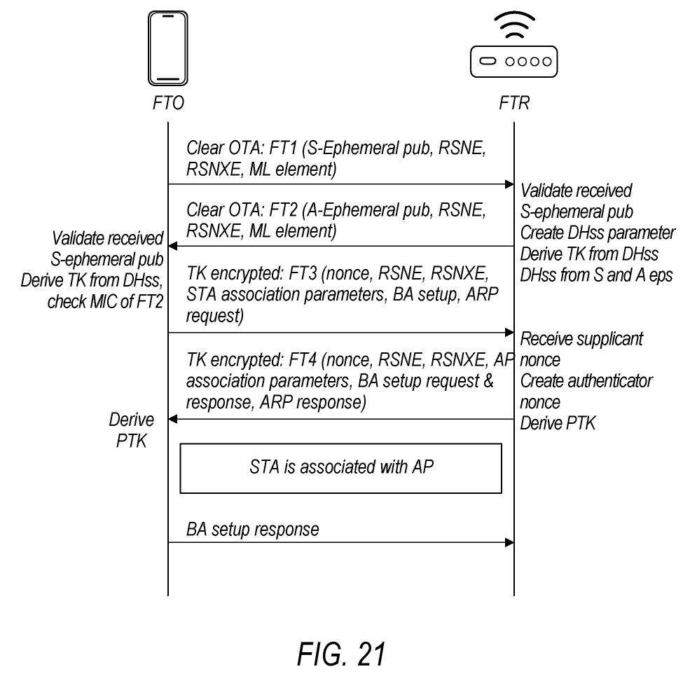

FIG. 21 illustrates example aspects of possible fast transition (FT) OTA signaling between an FT originator (FTO) and a FT responder (FTR) that can include IP address and BA setup, according to some embodiments. As shown, in the illustrated scenario, aggregated BA setup and ARP request signaling can be provided in the FT3 and FT4 frames, with an additional management frame for BA setup response after the STA is associated with the AP following the FT signaling. Thus, a STA can start IP address and BA setup quickly in FT roaming, which can potentially make data transmission possible more quickly and with less overhead.

Seamless roaming can make roaming faster, for example including by transferring context from the old serving AP to the new roaming target AP. The context can contain the STA’s IP address and BA setup(s), and in addition to these parameters, the context can also record the ongoing data transmissions status. This data transmission status included in the context for a STA can include the buffered DL data in the serving AP, the last transmitted Sequence Numbers (SNs) of UL and DL frames and the received Packet Numbers (PNs) of the transmitted UL and DL data. The context can also include the QoS settings, such as the Stream Classification Service (SCS) and Mirrored Stream Classification Service (MSCS).

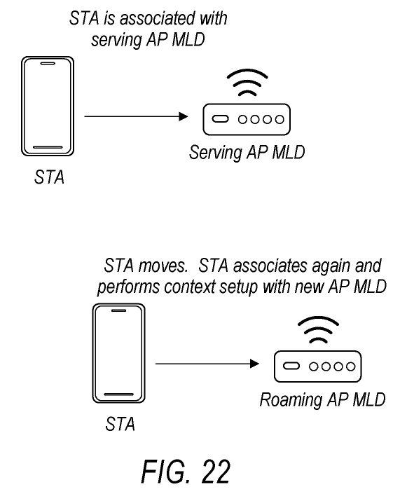

The context can be collected at the serving AP, for example by monitoring the ongoing data transmissions and by keeping record of the management traffic on SCS and MSCS settings during the association. FIG. 22 illustrates example aspects of possible context creation and transfer that could be performed in a seamless mobility domain (SMD), according to some embodiments. In the illustrated scenario, the context can be transferred from the old serving AP MLD to the target roaming AP MLD if the context still exists in the old serving AP MLD.

In some embodiments, the context recorded for a STA at a serving AP can be transmitted to a roaming target AP during seamless roaming operations, for example in which the STA prepares links to the roaming target AP MLD through its serving AP MLD. The prepared roaming target AP and the serving AP MLD can typically belong to the same SMD.

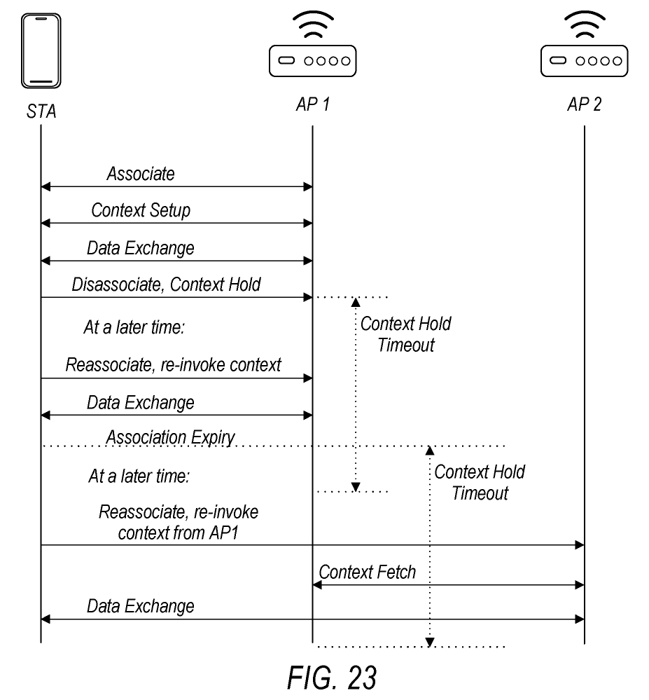

While this context use, e.g., only as a part of the prepared seamless roaming, can be useful, it can also potentially be useful to make use of STA context in other scenarios. For example, a STA can lose its association to the current serving AP. Currently, it may be the case that the context is maintained only for an association. Accordingly, one alternative possibility to ensure smooth return to the same serving AP could include to define a context lifetime that can allow context to be maintained longer than the association duration. For instance, an AP may be disassociated with an associated STA, if the STA operates in deep power save and the STA does not start obtaining the buffered traffic in a listen interval that is specified in the association signaling. In various embodiments, an AP may also or alternatively disassociate the STA for any other reason and the AP may not need to even provide any reason for the disassociation. If the STA associates again to the same AP, then supporting a context lifetime can potentially facilitate the STA being able to setup the same context that was ongoing before the disassociation. For example, setting up the context may allow the STA to fetch the buffered DL packets, continue transmissions on the same SN and PN values, setup the same block acknowledgement settings, continue using the same IP address, and continue using the same SCS and MSCS streams, e.g., with the same prioritization for the DL traffic. FIG. 23 is a signal flow diagram illustrating example aspects of a possible scenario in which context for a STA can be re-invoked (e.g., with the same AP or with a different AP) after disassociating and before a context hold timeout, according to some embodiments. Note that if the context transfer or retrieval is not possible, then the STA may still be able to setup the BA and IP address as described herein according to various embodiments.

The associated STA may have a management signaling mechanism, or the association signaling may configure the duration that the context is available after the STA is disassociated. Context may have a common lifetime or the lifetime may be information element specific. For instance, SN and PN maintenance may have shorter duration than the BA setup information or IP address, e.g., since if a STA has a long break in association, some context information may no longer be relevant (e.g., buffered data may be outdated and no longer usable, SN and PN continuation may not be relevant as only new data may be transmitted).

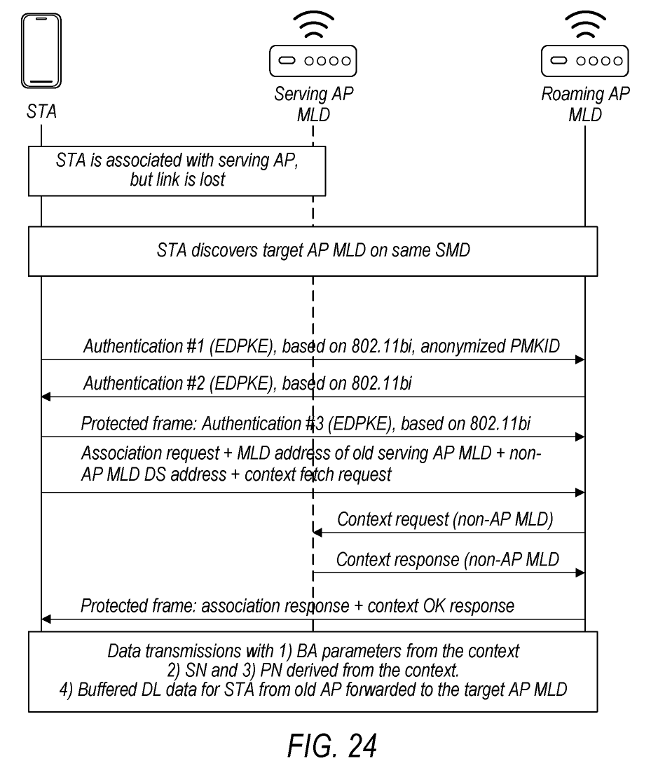

The context can be available also for cases in which the STA authenticates again to the network or to an AP in a SMD. FIG. 24 is a signal flow diagram illustrating example aspects of such a possible scenario in which a STA can perform association and context transfer signaling with a roaming AP MLD, according to some embodiments.

As shown, a STA may use the pairwise master key identifier (PMKID) to identify itself and the previous authentication, at least as one possibility. The PMKID can be a reference identifier to the previous authentication in the network. The PMKID can help the network to identify the STA. There may also be other alternatives for STA identification; for instance, a STA may use Device ID to identify itself or set the link address Initial Random MAC Address (IRMA). An alternative to STA identification may be to provide the MLD address of the last serving AP and the MLD address that the STA used when it associated with the AP MLD.

As noted herein, seamless roaming can be possible between the AP MLDs of a Seamless Mobility Domain (SMD). If the STA can be identified in authentication or through other means, it may be possible to transfer the context for a STA from the previous serving AP MLD, e.g., even if association with a current serving AP MLD is lost and the STA is unable to prepare seamless roaming links with a target roaming AP MLD through the serving AP MLD, which could potentially reduce the management frame overhead and delay to achieve data transmissions with the new serving AP MLD. For instance, if a STA authenticates by using PMKID or identifies itself during or after authentication, then the STA could request context transfer as encapsulated to the protected association signaling, as shown in FIG. 24. Alternatively, the STA may fetch the context after the association signaling. The context transfer in these cases may allow STA to transmit the DL and UL traffic as in seamless roaming.

The context transfer after an association has expired, or with any AP MLD in SMD after the STA has authenticated and identified itself, can potentially open new operation possibilities. For instance, it could be the case that a STA can relax the stand-by power save requirements and check buffered traffic more seldomly than if the STA were maintaining an association. The more seldom operation may lower the power consumption or mitigate in-device co-existence issues, e.g., in case the STA has multiple radios and simultaneous operation is not possible. Thus, a seamless roaming that is initiated through the roaming target AP MLD can potentially provide good roaming performance even if the STA is not able to send frames to the serving AP MLD.

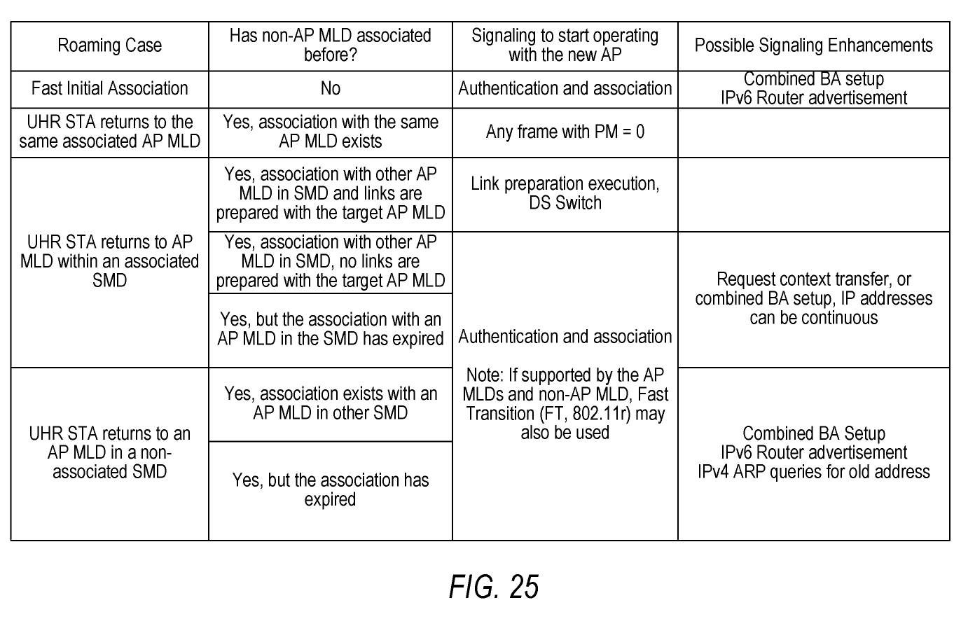

FIG. 25 is a table illustrating various possible roaming and association cases, including at least some cases in which techniques described herein could potentially be used to support faster, more efficient, and/or otherwise enhanced signaling, at least according to some embodiments. As shown, the various techniques described herein can potentially benefit use cases for fast initial association, use cases in which an ultra high reliability (UHR) STA returns to an AP MLD within an associated SMD and has no links prepared with the target AP MLD or the association with an AP MLD in the SMD has expired, and/or use cases in which a UHR STA returns to an AP MLD in a non-associated SMD, among various possibilities.

To support the techniques for faster association described herein, it can be possible that a frame format is used for one or more of association requests, association responses, reassociation requests, reassociation responses, and/or other frame types, that supports the inclusion of additional association information. For example, one or more such frame types for associating could be defined such that one or more fast initial link setup (FILS) higher layer protocol (HLP) container elements can be optionally present if the frame is protected, a FILS IP Address Assignment can be optionally present if the frame is protected, and/or that a combined BA setup element can be optionally present if the frame is protected, among various possibilities. Further, in an IP Address Data field for request, an IPv4 subfield value could be configured to indicate that a STA is requesting a check whether the IPv4 address of a previous association is still assigned, and/or an IPv6 subfield value could be configured to indicate that a STA is requesting router advertisement.

Note that in some embodiments it can be the case that an AP STA or non-AP STA can indicate one or more capabilities related to the various techniques described herein. For example, it could be possible that one or more bits of an extended capabilities field of an extended capabilities element transmitted by an AP STA can be configured to indicate support for checking whether an IPv4 address from a previous association is still assigned to a non-AP STA, to indicate support for checking whether an IPv6 address from a previous association is still assigned to a non-AP STA, and/or to indicate capability to use a combined BA setup element to setup block acknowledgements with a non-AP STA, among various possibilities.

Thus, in one example, an AP affiliated with an AP MLD can transmit a Beacon frame with set IPv4 Address Check field of the Extended Capabilities element to indicate that the AP MLD will check whether the IPv4 address of the previous association is still assigned to the DS address of the protected (Re)Association Request frame. To check whether the IPv4 address of the previous association is still assigned to the non-AP MLD, the non-AP MLD may include a FILS IP Address Assignment element with value 1 in the IPv4 field of the IP Address Request Control field and the previously used IPv4 address in the Requested IPv4 Address field to the protected (Re)Association Request frame. An AP MLD that receives such a protected (Re)Association Request frame can send a unicast ARP Request to the router. The ARP Request can contain the IPv4 address from the (Re)Association Request frame. If the ARP Response indicates that the IPv4 address is assigned to the DS address of the associating AP MLD, then the AP can set the DNS Info Control field IPv4 Address Still Assigned set to 1 in the FILS IP Address Assignment element of the (Re)Association Response frame. It can then be the case that the non-AP MLD that receives such an Association Response can continue to operate with the previously used IPv4 address, at least according to some embodiments.

In another example, an AP MLD can signal support for the IPv6 Router Advertisement encapsulation to the Protected Association Response frame by setting the IPv6 Router Advertisement field of the Extended Capabilities element of the Beacon and Probe Response frames it transmits. A protected (Re)Association Request frame can then contain a FILS IP Address Assignment element with IPv6 field set to value 1 in the IP Address Request field to solicit the Router Advertisement as part of the Association Response frame. The Router Advertisement can then facilitate the non-AP MLD to continue IPv6 address assignment operations. When the AP MLD receives such a (Re)Association Request frame, the AP MLD can encapsulate the latest received Router Advertisement to the FILS HLP element of the Association Response frame, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
performing, with an access point (AP) wireless device, key exchange signaling; and
performing, with the AP wireless device, protected association request and response signaling that includes at least one of Internet Protocol (IP) address setup signaling or Block Acknowledgement (BA) setup signaling.

2. The method of claim 1,
wherein the IP address setup signaling includes a request to use an IP address corresponding to a previous association with the AP wireless device.

3. The method of claim 2,
wherein the request to use the IP address corresponding to the previous association with the AP wireless device comprises at least one of an address resolution protocol (ARP) request, a router advertisement (RA) solicitation, or a dynamic host configuration protocol (DHCP) request.

4. The method of claim 1,
wherein the BA setup signaling includes at least one combined BA setup request for multiple user priorities (UPs).

5. The method of claim 4,
wherein the combined BA setup request comprises a UP bitmap that is configured to indicate which UPs are configured in the combined BA setup request.

6. The method of claim 1,
performing, with the AP wireless device, seamless roaming signaling that includes at least one of IP address continuation check signaling or BA setup signaling for seamless roaming to another AP wireless device.

7. The method of claim 1,
performing, with the AP wireless device, fast transition (FT) signaling that includes at least one of IP address setup signaling or BA setup signaling for FT roaming to another AP wireless device.

8. The method of claim 1, wherein the key exchange signaling includes at least one of:
enhanced data privacy key exchange (EDPKE) signaling;
pre-association security negotiation (PASN) signaling;
extensible authentication protocol (EAP) signaling; or
opportunistic wireless encryption (OWE) signaling.

9. A processor comprising memory configured to cause the processor to perform operations comprising:
generating a first key exchange frame that is configured for wireless transmission to an access point (AP) wireless device;
receiving, from the AP wireless device, a second key exchange frame;
generating an association request frame that is configured for wireless transmission to the AP wireless device, wherein the association request frame is protected using key information derived from the first and second key exchange frames, wherein the association request frame comprises at least one of Internet Protocol (IP) address setup signaling or Block Acknowledgement (BA) setup signaling; and
receiving, from the AP wireless device, an association response frame that comprises at least one of IP address setup signaling or BA setup signaling.

10. The processor of claim 9,
wherein the association request frame comprises a request to use an IP address corresponding to a previous association with the AP wireless device.

11. The processor of claim 10,
wherein the request to use the IP address corresponding to the previous association with the AP wireless device comprises at least one of an address resolution protocol (ARP) request, a router advertisement (RA) solicitation, or a dynamic host configuration protocol (DHCP) request.

12. The processor of claim 9,
wherein the association request frame comprises a combined BA request for multiple uplink (UL) user priorities (UPs),
wherein the association response frame comprises a combined BA response for the multiple UL UPs,
wherein the association response frame further comprises a combined BA request for multiple downlink (DL) UPs, and
wherein the memory is further configured to cause the processor to perform operations comprising:
generating a combined BA response frame that is configured for wireless transmission to the AP wireless device, wherein the combined BA response frame comprises a combined BA response for the multiple DL UPs.

13. The processor of claim 9, wherein the method further comprises:
generating a link preparation request frame that is configured for wireless transmission to the AP wireless device, wherein the link preparation request frame comprises at least one of IP address continuation check signaling or BA setup signaling; and
receiving, from the AP wireless device, a link preparation response frame that comprises at least one of IP address continuation check signaling or BA setup signaling.

14. The processor of claim 9, wherein the method further comprises:
generating a fast transition (FT) 3 frame that is configured for wireless transmission to the AP wireless device, wherein the fast transition frame comprises at least one of IP address setup request signaling or uplink (UL) BA setup request signaling; and
receiving, from the AP wireless device, a FT 4 frame that comprises at least one of IP address setup response signaling, UL BA setup response signaling, or downlink (DL) BA setup request signaling.

15. The processor of claim 14, wherein the method further comprises:
generating an additional management frame that is configured for wireless transmission to the AP wireless device after receiving the FT 4 frame, wherein the additional management frame comprises DL BA setup response signaling.

16. A first wireless device, comprising:
one or more antennas;
one or more radios operably coupled to the one or more antennas; and
a processor operably coupled to the one or more radios;
wherein the wireless device is configured to:
perform, with a second wireless device, key exchange signaling; and
perform, with the second wireless device, association request and response signaling that includes additional association setup signaling, wherein the association request and response signaling is protected using key information derived from the key exchange signaling.

17. The first wireless device of claim 16,
wherein the additional association setup signaling comprises a request to use an Internet Protocol (IP) address corresponding to a previous association with the AP wireless device.

18. The first wireless device of claim 16,
wherein the additional association setup signaling comprises at least one combined block acknowledgement (BA) setup request for multiple user priorities (UPs).

19. The wireless device of claim 16, wherein the first wireless device comprises a non-access point wireless device, wherein the second wireless device comprises an access point wireless device,
wherein to perform the key exchange signaling, the first wireless device is further configured to:
transmit, to the second wireless device, a first key exchange frame; and
receive, from the second wireless device, a second key exchange frame in response to the first key exchange frame,
wherein to perform the association request and response signaling, the first wireless device is further configured to:
transmit, to the second wireless device, an association request frame that comprises at least one of Internet Protocol (IP) address setup signaling or Block Acknowledgement (BA) setup signaling; and
receive, from the second wireless device, an association response frame that comprises at least one of IP address setup signaling or BA setup signaling.

20. The wireless device of claim 16, wherein the first wireless device comprises an access point wireless device, wherein the second wireless device comprises a non-access point wireless device,
wherein to perform the key exchange signaling, the first wireless device is further configured to:
receive, from the second wireless device, a first key exchange frame; and
transmit, to the second wireless device, a second key exchange frame in response to the first key exchange frame,
wherein to perform the association request and response signaling, the first wireless device is further configured to:
receive, from the second wireless device, an association request frame that comprises at least one of Internet Protocol (IP) address setup signaling or Block Acknowledgement (BA) setup signaling; and
transmit, to the second wireless device, an association response frame that comprises at least one of IP address setup signaling or BA setup signaling.
